(19) United States
(12) Patent Application Publication
(10) Pub. No.: US 2010/0218832 A1
(43) Pub. Date: Sep. 2, 2010

(54) MEDICAL GAS COUPLING

(76) Inventors: David Edgar Peel, Southwell (GB); Richard Radford, Nottingham (GB); Andrew Richard Thomas Tatarek-Gintowt, Hants (GB)

Correspondence Address: WEIDE & MILLER, LTD., 7251 W. LAKE MEAD BLVD., SUITE 530, LAS VEGAS, NV, 89128, US

(21) Appl. No.: 12/730,021

(22) Filed: Mar. 23, 2010

Related U.S. Application Data
(63) Continuation of application No. PCT/GB2008/003232, filed on Sep. 24, 2008.

(30) Foreign Application Priority Data
Sep. 25, 2007 (GB) 0718685.1

(51) Int. Cl. F16K 21/04

(52) U.S. Cl. 137/511

(57) ABSTRACT

A medical gas coupling comprises an inlet operable to couple with a pressurized therapeutic gas supply and an outlet operable to supply therapeutic apparatus, or an anallary unit associated therewith, with therapeutic gas. The coupling further comprises a conduit that extends between the inlet and the outlet and provides for the passage of pressurized gas therethrough. A safety valve is located in the region of the inlet and is operable to close the flow of gas through the conduit in the event that the pressure differential across the safety value exceeds a predetermined level.

### 1. CROSS-REFERENCE AND PRIORITY CLAIM TO RELATED APPLICATION

This application is a continuation of and claims priority to PCT Application No. PCT/GB2008/003232 titled Medical Gas Coupling, filed Sep. 24, 2008, which claims priority to Great Britain Application No. 0718685.1, filed Sep. 25, 2007.

### 2. FIELD OF THE INVENTION

The present invention relates to a medical gas coupling. More specifically, the present invention relates to a medical gas coupling including a safety valve.

### 3. RELATED ART

Medical gas, such as oxygen, is typically supplied to patients in hospitals, by emergency services and also in the domestic environment. Oxygen delivery systems may be classified as being fixed, portable, or ambulatory.

Fixed systems are typically provided in hospital wards. In a hospital environment, a central source of oxygen is carried by appropriate pipes to various locations throughout the hospital. Oxygen may be supplied to each patient via an outlet provided in a wall. A flow meter, generally of the glass and ball type, is attached to the wall outlet. A needle valve is provided as part of the flow meter to regulate oxygen flow to the patient. Flexible plastic tubing then connects the flow meter outlet to an administration device, such as a nasal cannula or mask, via which oxygen is delivered to a patient.

Oxygen is capable of combustion and of supporting combustion and the risks associated with fire while oxygen is being delivered to a patient are therefore particularly significant. Exposure of oxygen delivery apparatus to an ignition event, for example, an electrical short circuit or an open flame, can result in ignition, and an external fire may be supported by the oxygen supplied by the delivery apparatus. In extreme circumstances, the oxygen can support an external fire that may move to the interior of the flexible tubing and may migrate rapidly upstream towards the oxygen source.

When in operation, most oxygen delivery apparatus is set to deliver oxygen continuously at a rate determined by the needs of the patient, and removal of the delivery apparatus does not cause the delivery of oxygen to cease. In such circumstances, an oxygen enriched atmosphere can build up around a patient, resulting in an environment in which the smallest spark can cause a catastrophic conflagration.

In a known fixed oxygen system, connection of a flow meter to a wall outlet port opens the outlet port valve and allows pressurized oxygen from the source to fill the glass tube of the flowmeter. A needle valve in the region of the outlet of the flow meter may be set to a closed position to prevent oxygen flow into the ward when no gas is to be administered to a patient. It can, however, be seen that in the event that a fire occurs and a flow meter sustains damage, pressurized oxygen may be vented to atmosphere, and aid the progress of an existing fire.

In the event of a fire, the supply of pressurized oxygen may be turned off to a predetermined set of wall outlets (for example, a particular ward of a hospital). Making the decision to turn the oxygen supply off is, however, often complicated by the fact that a number of the wall outlets may be in use by patients requiring oxygen therapy.

### SUMMARY

It is an object of the present invention to provide a fixed oxygen system with improved safety.

Accordingly, the present invention provides a medical gas coupling comprising an inlet operable to couple with a pressurized therapeutic gas supply and an outlet operable to supply therapeutic apparatus, or an ancillary unit associated therewith, with therapeutic gas. As part of this embodiment is a conduit extending between the inlet and the outlet for the passage of pressurized gas therethrough, and a safety valve located in the region of the inlet, operable to close the flow of gas through the conduit in the event that the pressure differential across the safety valve exceeds a predetermined level.

In the event of a fire, provision of a safety valve in the region of the inlet mitigates the amount of pressurized oxygen, or other gas capable of combustion, that is available to sustain a fire. In particular, the safety valve closes the flow of gas through the conduit when the outlet vents to atmospheric pressure. In this case, the pressurized gas supply may, for example, be supplied at 4 bar pressure, and flow through the conduit may be maintained until the pressure differential across the safety valve is such that the gas in the region of the inlet is at supply pressure (in this case 4 bar) and the gas in the region of the outlet vents to atmosphere. When the pressure differential reaches that level, the safety valve moves to a closed position, preventing any further gas from entering the conduit of the coupling.

The inlet and safety valve may be formed from a substantially fire resistant material. Forming at least the inlet and the safety valve from a fire resistant material limits the effect of fire on the safety valve and the likelihood of burn back beyond the safety valve.

The safety valve may comprise a closure member located within the conduit, the closure member being resiliently biased towards an open position.

Resiliently biasing the closure member towards an open position serves to maintain the coupling in a state in which therapeutic gas may be supplied to a patient.

The conduit may be shaped to accommodate the closure member and biasing means. The conduit may comprise a narrow portion and a wide portion. The closure member may be housed in the wide portion of the conduit. The resilient biasing means may be housed in the narrow portion of the conduit. When the safety valve is closed, the closure member may move towards the narrow portion of the conduit, thereby blocking the flow of pressurized gas through the conduit. The closure member may be a substantially spherical member. The closure member may be substantially metal. For example, the closure member may take the form of a brass ball. The resilient biasing means may take the form of a spring.

The inlet of the coupling may be arranged such that it is operable to be inserted into, or otherwise couple with, a wall outlet. That wall outlet may form part of a fixed gas supply system.

The coupling may further comprise a retaining means for securing the inlet to the pressurized therapeutic gas supply. The retaining means may be an annular groove. That annular groove may be provided in the region of the inlet and may be located on an outer or inner surface of the coupling. The retaining means may comprise a threaded portion, or a bayonet type fitting. In each case the retaining means is arranged such that it may be secured to a wall outlet in a gas tight manner.

The outlet of the coupling may be operable to supply a gas flow meter with gas. The outlet may couple in a gas-tight manner with an inlet of a flow meter.

Provision of a coupling having an outlet which is operable to couple with a flow meter allows the medical gas coupling to be retro-fitted to an existing fixed gas supply system.

The conduit may pass through a gas flow meter. The coupling may form part of a gas flow meter. The coupling may be integrally formed with a gas flow meter. The gas flow meter may be of a ball and glass type, allowing a variable flow therethrough or may be of the fixed orifice type. The outlet of the coupling may be the outlet of a gas flow meter.

Providing a flow meter with an integral coupling (and therefore safety valve) may simplify the assembly of a fixed gas supply system. Various other ancillary units may be integrally formed with a coupling according to the present invention, for example, a gas blender.

The coupling outlet may incorporate an assembly having a connector nozzle by which the therapeutic apparatus, or an ancillary unit associated therewith, is supplied with gas.

The assembly may be connectable to a gas delivery line. The assembly may itself be a fire safety valve. The assembly may comprise a valve body, a valve member having a valve head resiliently biased towards a valve closure position and a fusible retainer holding the valve member, against the bias, in a valve open position.

The assembly may be integrally formed with the coupling or may be removable from the coupling outlet.

The present invention further provides a gas flow meter including a medical gas coupling comprising an inlet operable to couple with a pressurized therapeutic gas supply and an outlet operable to supply the flowmeter with therapeutic gas. A conduit is provided which extends between the inlet and the outlet for the passage of pressurized gas therethrough. A safety valve located in the region of the inlet is provided and is operable to close the flow of gas through the conduit in the event that the pressure differential across the safety valve exceeds a predetermined level.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views. By way of example only, an embodiment of the present invention will now be described with reference to the accompanying drawings.

FIG. 1 is a perspective view of a ball and glass flow meter incorporating a coupling according to the present invention.

FIG. 2 is a cross sectional view of the flow meter shown in FIG. 1.

FIG. 3 is an enlarged cross sectional view of the region “D” of FIG. 2.

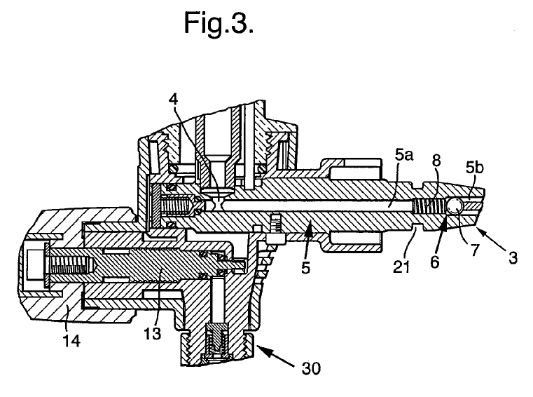

### DETAILED DESCRIPTION

The invention shall be described in the orientation shown in the drawings.

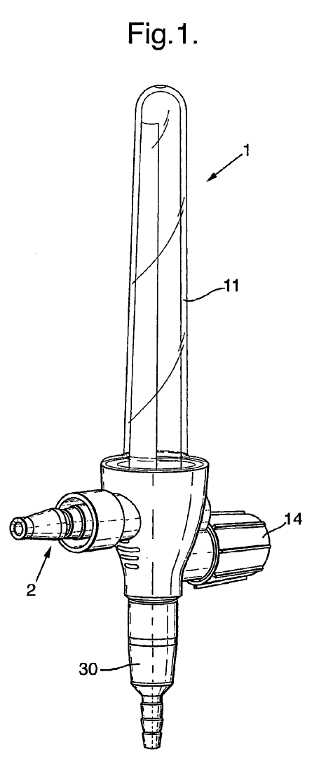

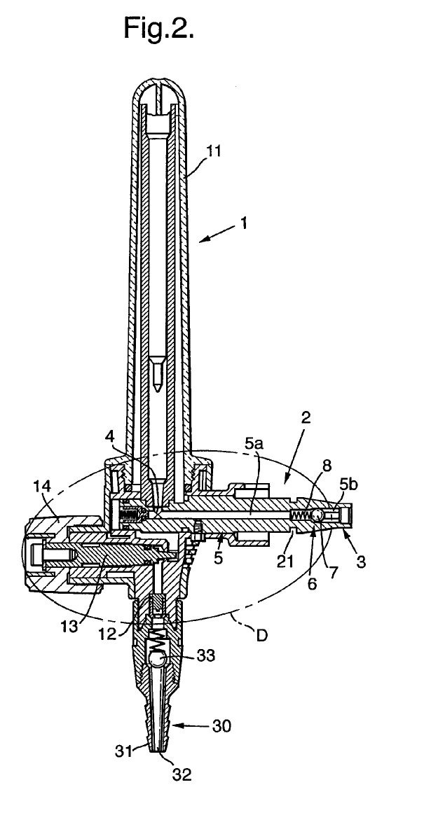

FIG. 1 shows a gas flow meter 1 including a medical gas coupling 2 according to the present invention. As can be seen more clearly in cross sectional view of FIG. 2, the coupling 2 is integrally formed with the flow meter 1 and comprises an inlet 3 operable to couple with a pressurized therapeutic gas supply (not shown), an outlet 4 operable to supply the flow meter 1 with therapeutic gas; and a conduit 5 extending between the inlet and the outlet for the passage of pressurized gas therethrough. The coupling 2 also comprises a safety valve 6 located in the region of the inlet 3. The safety valve 6 is operable to close the flow of gas through the conduit 5 in the event that the pressure differential across the safety valve 6 exceeds a predetermined level.

The safety valve comprises a closure member in the shape of a ball 7, located in the conduit 5, resiliently biased towards an open position by a spring 8.

In addition to the coupling, the flow meter 1 further comprises a tapered glass tube 11 containing a ball (not shown), able to “float” on a stream of gas flowing from the source through the flow meter and out of the flow meter outlet 12. The rate of flow of gas through the flow meter is controlled by a needle valve 13. Operation of the needle valve is itself controlled by flow meter controller 14. As the controller 14 is turned, an orifice around the needle valve 13 becomes larger, thereby allowing the flow of gas through the flow meter outlet 12 to increase. As the gas flow rate through the flow meter is increased, the ball contained in the tapered glass tube 11 is carried further up the tube, and acts as a visual representation of the gas flow from the flow meter outlet 12.

Returning now to the coupling according to the present invention, resiliently biasing the closure member towards an open position serves to maintain the coupling in a state in which therapeutic gas may be supplied to a patient and gas is able to flow through the flow meter 1 as described immediately above.

The conduit 5 of the coupling is shaped to accommodate the closure ball 7 and spring 8. The conduit 5 has a narrow portion 5a and a wide portion 5b. The ball 7 is housed in the wide portion of the conduit. The spring 8 may be housed in the narrow portion 5a of the conduit 5.

In normal operation pressurized gas flows from the source (not shown) into the inlet 3 and around the ball 7, located in the wide portion of the conduit 5b. in normal circumstances, the pressure differential of the gas across the ball 7 is such that the spring, located in the narrow portion of the conduit 5a is able to hold the ball in position such that the gas can flow around it, towards the outlet 4 of the coupling.

In the event that the pressure differential across the safety valve 6 is above a predetermined level (set by the strength of the spring 8), the pressurized gas flowing into the inlet pushes against the ball such that the spring 8 can no longer hold the ball in position in the wide portion of the conduit. The ball is moved by the pressure of the gas against it into a position abutting the narrow portion of the conduit and gas is no longer able to flow towards the outlet 4 of the coupling.

Such a pressure differential may occur if the pressure at the outlet is substantially atmospheric pressure, for example, if the gas flow meter 1 is damaged. Typically a pressurized medical gas, for example, oxygen, will be piped to a wall outlet at a pressure of around 4 bar. In the event that the pressure at the coupling outlet 4 is substantially atmospheric, that is to say, venting to atmosphere, the spring 8 will no longer be able to hold the ball 7 in the open position.

The inlet and closure member of the safety valve are formed from a substantially fire resistant material, namely brass. Forming these parts from a fire resistant material limits the effect of a fire on the operation of the safety valve and the likelihood of any burn back beyond the safety valve.

The inlet 3 of the coupling 2 is arranged such that it is operable to be directly inserted into, or otherwise couple with, a wall outlet. The coupling 2 further comprises a retaining means for securing the inlet 3 to the pressurized therapeutic gas supply (not shown). In the embodiment shown, the retaining means is an annular groove 21 located on an outer surface the coupling. The retaining means is arranged such that the coupling can be secured to a wall outlet in a gas tight manner.

In the embodiment shown, the flow meter outlet 12 incorporates a removable assembly 30 having a connector nozzle 31 by which the therapeutic apparatus, or an ancillary unit associated therewith (not shown) is supplied with gas.

The nozzle 31 is connectable to a gas delivery line (not shown) which in turn leads to the delivery outlet of gas delivery apparatus, for example a nasal cannula or facemask.

The removable assembly 30 is itself a fire safety valve. The safety valve is one having a heat sensitive element 32 located in the nozzle 31 which, should a fire occur at the delivery end of the apparatus, detect a rise in the temperature as a flame front approaches along the gas delivery line and fuses to allow a valve element 33 within the assembly 30 to close, thereby isolating the flow meter 1 and the remainder of the delivery apparatus, including the source of combustion supporting gas (usually oxygen) from the fire.

Although a particular embodiment has been described herein it will be apparent that the invention is not limited thereto, and that many modifications and additions may be made within the scope of the invention. It will, for example, be understood, that the removable assembly may be integrally formed with the flow meter, or that the coupling may be formed separately from the flow meter. For example, various combinations of the features from the embodiment and the following dependent claims could be made with features of the independent claims without departing from the scope of the present invention.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A medical gas coupling comprising: an inlet operable to couple with a pressurized therapeutic gas supply, an outlet operable to supply therapeutic apparatus, or an ancillary unit associated therewith, with therapeutic gas; a conduit extending between the inlet and the outlet for the passage of pressurized gas therethrough, and a safety valve located in the region of the inlet, operable to close the flow of gas through the conduit in the event that the pressure differential across the safety valve exceeds a predetermined level.

2. The medical gas coupling according to claim 1, wherein the inlet and safety valve are formed from a substantially fire resistant material.

3. The medical gas coupling according to claim 1, wherein the safety valve comprises a closure member located within the conduit, the closure member being resiliently biased towards an open position.

4. The medical gas coupling according to claim 1, further comprising a retaining means for securing the inlet to the pressurized therapeutic gas supply.

5. The medical gas coupling according to claim 4, wherein the retaining means is an annular groove.

6. The medical gas coupling according to claim 1, wherein the outlet is operable to supply a gas flow meter with gas.

7. The medical gas coupling according to claim 1, wherein the conduit passes through a gas flow meter.

8. The medical gas coupling according to claim 1, wherein the coupling forms part of a gas flow meter.

9. The medical gas coupling according to claim 1, further comprising an assembly having a connector nozzle by which the therapeutic apparatus, or ancillary unit associated therewith, is supplied with gas.

10. The medical gas coupling according to claim 9, wherein the assembly further comprises a fire safety valve.

11. The medical gas coupling according to claim 10, wherein the assembly comprises a valve body, a valve member having a valve head resiliently biased towards a valve closure position and a fusible retainer holding the valve member, against the bias, in a valve open position.

12. The medical gas coupling according to claim 9, wherein the assembly is integrally formed with the coupling.

13. The medical gas coupling according to claim 9, wherein the assembly is removable.

14. A gas flow meter including a medical gas coupling comprising: an inlet operable to couple with a pressurized therapeutic gas supply, an outlet operable to supply the flow meter with therapeutic gas; a conduit extending between the inlet and the outlet for the passage of pressurized gas therethrough, and a safety valve located in the region of the inlet, operable to close the flow of gas through the conduit in the event that the pressure differential across the safety valve exceeds a predetermined level.
